(19) United States
(12) Patent Application Publication
(10) Pub. No.: US 2016/0177987 A1
(43) Pub. Date: Jun. 23, 2016

(54) CONNECTING ELEMENT

(71) Applicant: Fill Gesellschaft m.b.H., Gurten (AT)

(72) Inventors: Rudolf GRADINGER, Schwechat (AT); Harald SEHRSCHOEN, Waldzell (AT); Stephan UCSNIK, Ranshofen (AT)

(73) Assignee: Fill Gesellschaft m.b.H., Gurten (AT)

(21) Appl. No.: 14/910,402

(22) PCT Filed: Aug. 6, 2014
(86) PCT No.: PCT/AT2014/050172

§ 371 Date: Feb. 29, 2016

(30) Foreign Application Priority Data
Aug. 6, 2013 (AT) A 50492/2013

(51) Int. Cl. F16B 5/07; A44B 18/00; B21D 28/10

(52) U.S. Cl. CPC F16B 5/07; B21D 28/10; A44B 18/0061

(57) ABSTRACT

Method for producing a connecting element (1) and a connecting element (1) for connecting at least two material layers, which has a grid-shaped carrier structure (4), and retaining/penetrating elements (2) protruding from the carrier structure (4) are arranged on at least one side of the carrier structure (4), each having at least one free head end (5) serving to penetrate at least one of the material layers, which are connected to the carrier structure (4) by means of at least one connection point (3) each, and the retaining/penetrating elements (2) each have a second free head end (6) opposite the first head end (5) and the connection points (3) of the respective retaining/penetrating elements (2) lie outside a load path from the first free head end (2) to the second free head end (6).

The invention relates to a method for producing a connecting element for connecting at least two material layers produced from a flat base material, whereby in a first step, at least one contour of at least one retaining/penetrating element having at least one free head end serving to penetrate at least one of the material layers is cut or punched out from the plate-shaped base material, and at least one connection point by means of which the retaining/penetrating element remains connected to the rest of the base material is left intact when cutting or punching the contour, and in a second step the at least one free head end of the at least one retaining/penetrating element is moved out of a plane of the plate-shaped base material into an end position lying outside of this plane, and when the head end has been moved into the end position, the at least one retaining/penetrating element remains connected by means of the at least one connection point to another retaining/penetrating element and/or to the rest of the base material which forms a carrier structure for the at least one load-bearing structure.

The invention further relates to a connecting element for connecting at least two material layers having a carrier structure, and retaining/penetrating elements protruding from the carrier structure, each having at least one free head end serving to penetrate at least one of the material layers, are provided on at least one side of the carrier structure and are each connected to the carrier structure by means of at least one connection point.

In the automotive and aeronautical industries, the use of fiber composite materials is becoming increasingly widespread. Composite materials of fiber mats or films and materials such as metal, for example, are used for this purpose. Also very common is the use of a sandwich material where a material layer of a first laminate and a second material layer also of a laminate are joined to one another by a connecting element disposed between them and glued by means of a resin. The retaining/penetrating elements serve as reinforcement and act as load-bearing structures in the sandwich material. Known connecting elements have grid-shaped carriers made from metal which protrude out from the retaining and penetrating elements, for example in the form of hooks. The purpose of the head ends of the retaining/penetrating elements is to penetrate a material layer and establish a mechanical connection between the material layers to be connected.

A method and a connecting element of the type outlined above are known from WO 2006/037642. In order to produce the known connecting element, hook-shaped retaining/penetrating elements are punched from a sheet in such a way that they are joined to the sheet solely at a base region lying opposite a head end. The retaining/penetrating elements are then bent in the base region which means that a bend is created in this region. The main disadvantage of this is that when the sandwich material is in an assembled state, the bend has to endure a very high number of stress cycles, which can result in fatigue to the point of rupturing the bending point. Another disadvantage is that the bend is in a load path and must be capable of withstanding very high peak loads. Bending also leads to a change in cross-section and to the formation of a geometric notch at the bend point. Due to bending, some of the deformability of the material is used during production of the retaining/penetrating elements already. Furthermore, in the region of the bend, the known connecting element has a curvature towards boundary surfaces of the material layers to be connected to one another. This can lead to the inclusion of air or to the formation of resin pockets, increasing the risk of crack propagation at an interface between the material layers.

Accordingly, the objective of the invention is to overcome the disadvantages of the prior art outlined above.

This objective is achieved by the invention on the basis of a method of the type outlined above, whereby in the first step, the retaining/penetrating element is punched to the degree that a second free head end lying opposite the first free head end is created and the at least one connection point lies outside a load path from the first free head end to the second free head end.

Based on the solution proposed by the invention, the connection point does not lie in the load path of the retaining/penetrating element because the two oppositely lying head ends across which a load is transmitted between the two material layers are designed as free ends. Due to the carrier structure, the retaining/penetrating elements can be optimally positioned between the material layers to be connected to one another.

The solution proposed by the invention also avoids any necking of the material in the load path because the connection point to the carrier structure does not lie in the force flow between the two material layers to be connected. The material layers may be provided in the form of films, laminates, woven fabrics, prepreg materials, fiber-reinforced plastics such as carbon fiber-reinforced polymer, wood, pressed boards of all types, etc. The expression “material layer” in this context should be understood as meaning a material that is not only made up of a single layer but also one which is made up of several layers.

The connecting element proposed by the invention may be produced from any suitable base material of constant or variable thickness, for example metal, plastic, organic sheet, fiber-reinforced plastic, composite materials and sandwich materials or from the same materials as the material layers to be connected to one another. The base material may be of the plate-shaped type, for example in the form of a sheet, or alternatively may have a waved cross-sectional structure. The base material used may also be in the form of a corrugated sheet, for example. Using a base material with a waved cross-sectional structure enables a greater moment of inertia and a higher section modulus to be obtained so that higher bending moments can be absorbed. The base material from which the connecting element is made may also be coated, for example with lacquers, functional surface coatings, and the surface of the base materials may also be provided with a surface structure, for example a micro-structure. In particular, the base material may be coated with a primer with very good properties in terms of crosslinking with a binding agent used to connect the two material layers, for example a resin. The base material may be coated using a coil-coating-method, for example.

Based on one advantageous variant of the invention which is distinctive due to very good mechanical properties, during the second step, the two head ends of the retaining/penetrating element are turned out of the plane of the plate-shaped base material without bending a load-bearing cross-section of the retaining element/penetrating element.

The dent resistance of the retaining/penetrating element can be increased by making at least one crimp in the retaining/penetrating element. Another option is to use an already crimped base material, for example a corrugated sheet.

The density of the layout of the retaining/penetrating elements can be increased if, after the second step, the carrier structure is sheared in at least one direction.

An optimum connection to the material layers can be guaranteed if, after the second step, the carrier structure is reshaped to match a contour of the material layers to be connected to one another.

To enable the best possible penetration of the carrier structure of the connecting element by a binding agent or adhesive used to connect the two material layers, such as resin for example, several retaining elements can be cut out in the first step, and base material disposed between head ends on the next adjacent retaining elements can be completely cut or punched out. In this manner, the amount of remaining base material from which the carrier structure is made can be minimized.

The objective outlined above can also be achieved by means of a connecting element of the type described above where the retaining/penetrating elements each have a second free head end lying opposite the first head end and where at least one connection point of the respective retaining/penetrating elements lies outside a load path from the first free head end to the second free head end.

It has also proved to be of advantage if the connecting element has a meandering shape. One or both of the head ends of the retaining/penetrating element may have retaining structures, for example barbed hooks, hooks with multiple barbs, projections, undercuts, etc., or alternatively just simple tips. Each of the retaining/penetrating elements may also be provided with a shank lying between the two head ends.

Based on one advantageous variant of the invention, the distance of the two head ends of a retaining/penetrating element from a surface of the carrier structure may be the same or different. In other words, the retaining/penetrating elements may be disposed symmetrically or asymmetrically relative an axis of rotation intersecting the connection point(s). The head ends of a retaining/penetrating element may be disposed on opposite sides of the carrier structure spaced at a distance apart therefrom so that the retaining/penetrating element extends completely through the carrier structure and protrudes out from both sides of it. Alternatively, the connection points to the carrier structure may also be selected so that, once turned, the retaining/penetrating element protrude from only one side of the carrier structure.

Based on another advantageous embodiment of the solution proposed by the invention, free head ends of different retaining elements/penetrating elements disposed on the same side of the carrier structure may be disposed at different distances from a surface of the carrier structure. Put simply, the heights of the retaining elements may differ based on this embodiment. This prevents the creation of a preferred shearing plane between the two material layers to be connected to one another and significantly increases the load-bearing capacity of the resultant composite material overall.

In order to increase stiffness, the retaining elements/penetrating elements may have at least one crease extending in at least certain regions between the free head ends.

To provide a clearer understanding, the invention will be described in more detail with reference to the appended drawings.

These are highly simplified, schematic diagrams illustrating the following:

FIG. 1 a perspective view of a connecting element proposed by the invention;

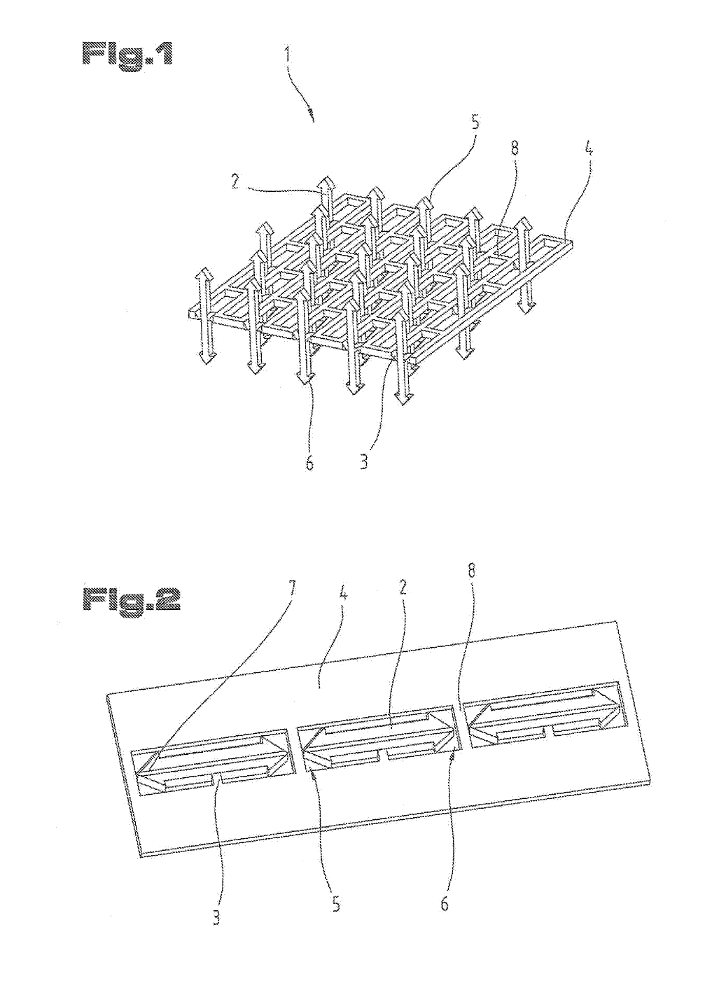

FIG. 2 a plan view of an as yet unfinished connecting element, with the retaining elements/penetrating elements and carrier structure still lying in one plane;

FIG. 3 a perspective view of a connecting element where the retaining element/penetrating elements have been turned out of the plane of the carrier structure;

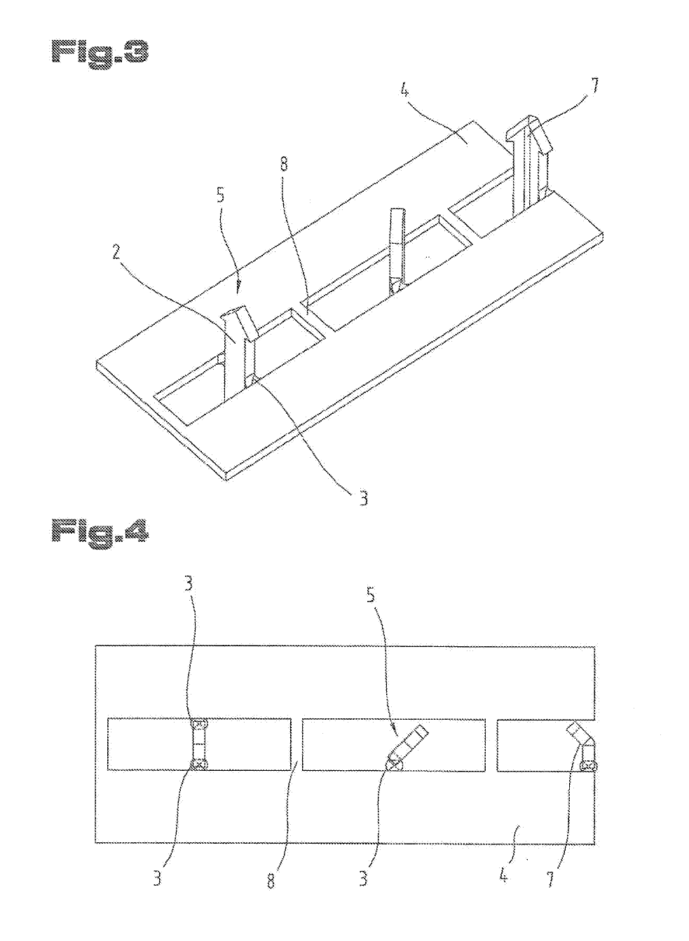

FIG. 4 a plan view of the connecting element illustrated in FIG. 3;

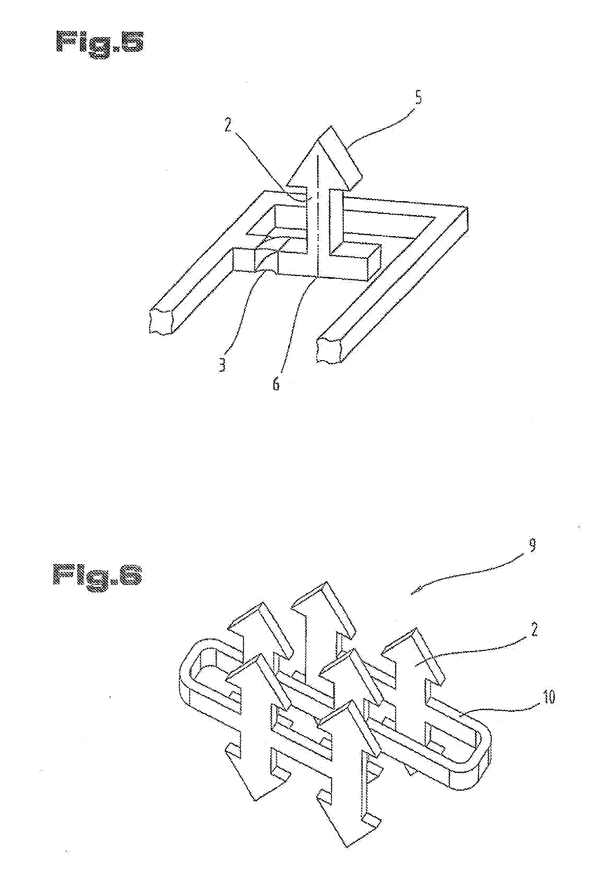

FIG. 5 a perspective view of a variant of the connecting element proposed by the invention and

FIG. 6 another variant of a connecting element proposed by the invention.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

As illustrated in FIG. 1, a connecting element 1 proposed by the invention has retaining/penetrating elements 2 which are connected to a grid-shaped carrier structure 4 via connection points 3.

The retaining/penetrating elements 2 have free head ends 5 lying opposite one another in the longitudinal direction of the retaining/penetrating elements 2.

The connection points 3 of the respective retaining/penetrating elements 2 lie outside a load path from the first free head end 5 to the second free head end 6 and may be disposed laterally on a shank of the respective retaining/penetrating elements 2 extending between the two head ends 5 and 6.

Although the retaining/penetrating elements 2 illustrated here are each shown with a straight shank, the shanks may also have a curving, snake-shaped contour or any other contour. The head ends 5 and 6 may also be of a different design from that illustrated in the embodiments.

For example, the head end 5 of a retaining/penetrating element 2 may be of a design that is different from that of its head end 6.

The distance of the two head ends 5, 6 of a retaining/penetrating element 2 from a surface of the carrier structure may be the same, as illustrated, or different.

By contrast with the diagram of FIG. 1, head ends 5, 6 of different retaining element/penetrating elements 2 disposed on the same side of the carrier structure 4 may also be disposed at different distances from a surface of the carrier structure 4.

As illustrated in FIG. 5, the connection point 3 may also be disposed laterally on a head end 5 or 6 so that the retaining/penetrating elements 2 protrude from the carrier structure 4 on one side only.

As illustrated in FIGS. 2-4, individual ones or all of the retaining elements/penetrating elements 2 have a crease 7.

The production method proposed by the invention will be described in more detail with reference to FIGS. 1-6.

In a first step, as illustrated in FIG. 2, the contours of the retaining/penetrating elements 2 are cut or punched from a plate-shaped base material. Only the connection points 3 by which the retaining/penetrating element 2 remains connected to the rest of the base material are left intact during a cutting or punching operation. The contour is therefore cut to the degree that the head ends 5 and 6 provided as a means of penetrating the material layers to be connected to one another are left as free ends.

The crease 7 can be made at the same time as cutting/punching or beforehand or afterwards. Alternatively, a crimped base material may also be used, e.g. a corrugated sheet.

Webs 8 disposed between the cut/punched contours of the retaining/penetrating elements 2 can also be removed if necessary in order to increase the surface area of the carrier structure 4 made freely available for penetration by a binding agent.

In a second step, the retaining/penetrating elements 2 are then turned about their connection points 3 relative to the carrier structure 4, for example into the end positions illustrated in FIGS. 1, 3 to 5.

The resultant connecting element 1 illustrated in FIG. 1 can then be further processed by shearing its carrier structure 4 in order to reduce distances between the individual retaining/penetrating elements 2. The carrier structure 4 may also be reshaped to match a contour of the material layers to be connected to one another.

As illustrated in FIG. 6, the connecting element 9 may also have a meandering structure, in which case the carrier structure 10 may be identical to the connection points so that the retaining/penetrating elements 2 are ultimately connected to one another by the connection points. By bending the carrier structure 10 or the connection points between the retaining/penetrating elements 2, the embodiment illustrated in FIG. 6 can be obtained.

For the sake of good order, finally, it should be pointed out that in order to provide a clearer understanding of the structure of the connecting element, it and its constituent parts are illustrated to a certain extent out of scale and/or on a larger scale and/or on a smaller scale.

### LIST OF REFERENCE NUMBERS

1 Connecting element
2 Retaining/penetrating element
3 Connection point
4 Carrier structure
5 First head end
6 Second head end
7 Crease
8 Web
9 Connecting element
10 Carrier structure

1-11. (canceled)

12: Method for producing a connecting element (1) for connecting at least two material layers produced from a flat base material, whereby during a first step at least one contour of at least one retaining/penetrating element (2) having at least one free head end (5) serving to penetrate at least one of the material layers is cut out or punched from the plate-shaped base material, and at least one connection point (3) by means of which the retaining/penetrating element (2) remains connected to the rest of the base material is left intact when cutting or punching the contour, and in a second step the at least one free head end (5) of the at least one retaining/penetrating element (2) is moved out of a plane of the plate-shaped base material into an end position lying outside this plane, and after moving the head end (5) into the end position the at least one retaining/penetrating element (2) remains connected via the at least one connection point (3) to another retaining/penetrating element (2) and/or to the rest of the base material which forms a carrier structure (4) for the at least one load-bearing structure (2), and during the first step, the retaining/penetrating element (2) is punched to the degree that a second free head end (6) lying opposite the first free head end (5) is formed and the at least one connection point (3) lies outside a load path from the first free head end (2) to the second free head end (6), wherein during the second step, both head ends (5, 6) of the retaining/penetrating element (2) are turned out of the plane of the plate-shaped base material so that the head ends (5, 6) of the retaining/penetrating element (2) are disposed on opposite sides of the carrier structure at a distance apart therefrom and the retaining/penetrating element extends completely through the carrier structure and protrudes out from both sides of it, without deforming a load-bearing cross-section of the retaining/penetrating element (2).

13: Method according to claim 12, wherein at least one crease (7) is made in the retaining/penetrating element (2).

14: Method according to claim 12, wherein the carrier structure (4) is sheared in at least one direction after the second step.

15: Method according to claim 12, wherein the carrier structure (4) is reshaped to match a contour of the material layers to be connected to one another after the second step.

16: Method according to claim 12, wherein during the first step, several retaining/penetrating elements (2) are cut out and base material disposed between head ends (5, 6) on the next adjacent retaining element (2) is completely cut out or punched out.

17: Connecting element (1) for connecting at least two material layers having a carrier structure (4), retaining/penetrating elements (2) protruding from the carrier structure (4) being disposed on at least one side of the carrier structure (4), each having at least one free head end (5) serving to penetrate at least one of the material layers, which are each connected to the carrier structure (4) via at least one connection point (3), wherein it is produced by a method according to claim 12 and the retaining/penetrating elements (2) each have a second free head end (6) lying opposite the first head end (5) and the at least one connection point (3) of the respective retaining/penetrating elements (2) lies outside a load path from the first free head end (2) to the second free head end (6) so that the head ends (5, 6) of the retaining/penetrating element (2) are disposed on opposite sides of the carrier structure at a distance apart therefrom and the retaining/penetrating element extends completely through the carrier structure and protrudes out from both sides of it.

18: Connecting element according to claim 17, wherein the distance of the two head ends (5, 6) of a retaining/penetrating element (2) from a surface of the carrier structure is the same or different.

19: Connecting element according to claim 18, wherein free head ends (5, 6) of different retaining elements/penetrating elements (2) disposed on the same side of the carrier structure (4) are disposed at different distances from a surface of the carrier structure (4).

20: Connecting element according to claim 17, wherein the retaining elements/penetrating elements (2) have at least one crease (7) extending in at least certain regions between the free head ends (5, 6).

21: Connecting element according to claim 17, wherein the connecting element is of a meandering or spiral-shaped design.
